(19) United States
(12) Patent Application Publication
(10) Pub. No.: US 2011/0115797 A1
(43) Pub. Date: May 19, 2011

(54) Dynamic Streaming of Font Subsets

(76) Inventor: Gregory A. Kaplan, Seattle, WA (US)

(21) Appl. No.: 12/622,201

(22) Filed: Nov. 19, 2009

(51) Int. Cl. G06T 11/00; G06F 17/00

(52) U.S. Cl. 345/467; 715/269

(57) ABSTRACT

Various embodiments of methods and systems for performing dynamic streaming of font subsets are described. In some embodiments, an application executing on a client device determines that glyphs of a font required to display a content portion of a file are not currently available. The application sends a request for the glyphs to a remote server. The server sends a reply to the application containing the glyphs. In some embodiments, an application populates a portion of a font data structure with glyphs sent by a remote server. A font data structure may be stored in persistent storage to be used by subsequent executions of the same or another application. Subsequent executions of applications may add additional glyphs to a font data structure. In some embodiments an application may request a definition of a font data structure from a server, and the server may provide the definition to the application.

### BACKGROUND

Displayable content in electronic systems often relies upon sets of glyphs, referred to as fonts, to specify the visual characteristics of characters in Western languages and ideograms in Asian languages. There are various means that an application displaying content may employ to access information for the glyphs required by a document. One method of providing the required glyphs is to make files containing descriptions of all glyphs in all fonts required by the document accessible, on local or network storage, to the device running the application. For example, font files containing TrueType fonts may be stored in the Windows/Fonts folder of a computer running the Microsoft Windows operating system, in files with a “.ttf” suffix. Similar files on a Macintosh computer may be stored in files in the System/Fonts folder, or in /usr/share/fonts on a computer with the Linux operating system. Font files contain information for displaying the glyphs defined in the font. In TrueType fonts the files comprise descriptions of straight line segments and quadratic Bézier curves for each glyph defined in the font along with a hinting mechanism to improve the appearance of glyphs at various sizes. If the required font file is not available then the font file must be obtained, possibly with user intervention. When the file for a particular font cannot be obtained, the content may be displayed using glyphs from a font that is available on the device running the application. This may result in the displayed content not appearing as the content-author intended. In some cases the device may not have a suitable font available (for example, the content may require Chinese language ideograms and the device executing the application only has Western language fonts available), potentially making the content effectively not displayable on the device.

An alternative to making complete font files accessible on a device is to embed fonts required by displayable content within the file containing the content. The PDF document format, for example, allows font embedding. Font embedding effectively embeds a font file as might be found in a system folder, as described above, in a document file. This method may guarantee that the required glyphs will be available to the application, but the content files will be larger due to the added information that they contain. Font description information, particularly for Asian languages, can be quite large. The font information may be large enough that download time through a network for content files containing embedded font information may become unacceptably long. In addition, font description information embedded with displayable content is typically not shared among different instances of content. Each instance of displayable content may have its own embedded copy of font information. For large numbers of content files the extra storage required by multiple copies of font description information may become burdensome on the device. A modification of this method embeds references to font description information instead of the information itself, and downloads the required fonts when the content is displayed. This provides smaller file sizes than embedding the font information but requires downloading of the font information each time the content is viewed rather than only once when the content is acquired by a user or when a font file is installed.

### SUMMARY

Various embodiments of methods and apparatus for dynamically streaming font subsets are described. In some embodiments, an application program executing on a client device analyzes a content portion of a document. The content portion contains one or more characters specified in the file to be displayed in a particular font. The application determines that the glyphs required to display the characters in the particular font are not currently available, and sends a message identifying the glyphs to a remote server. The glyphs are less than all of the glyphs defined in the font (e.g., the glyphs are a proper subset of the glyphs defined in the font) and depend on the characters needed by the content portion. The remote server receives the request and provides the requested glyphs to the application on the client device. In some embodiments the application may store the glyphs in a font data structure.

In some embodiments, a font data structure on a client device may be stored in persistent storage. A font data structure in persistent storage may make glyphs in the font data structure currently available to subsequent executions of the application or executions of other applications. Subsequent executions of an application may add additional glyphs to the font data structure.

In some embodiments, an application may determine that a font data structure for a particular font is not available and may request the definition of the font data structure from a remote server. The request for a definition of a font data structure may be included with a request for glyphs or the request may be sent as a separate request.

In some embodiments, a server receives requests for glyphs from a remote application on a client device and sends replies containing the requested glyphs. In some embodiments, a server may provide definitions of font data structures in response to requests from remote client applications. In other embodiments, a server may determine whether a request from a remote application on a client device should be fulfilled.

The methods described herein may be implemented as program instructions (e.g., stored on computer-readable storage media) executable by a CPU. For example, they may be implemented as program instructions that, when executed, implement dynamic streaming of font subsets in response to a request to display a content portion of a file.

### BRIEF DESCRIPTION OF THE DRAWINGS

FIG. 1 illustrates a client-server system for dynamically streaming fonts, according to one embodiment.

FIG. 2 illustrates an example implementation of a client application, according to one embodiment.

FIG. 3 illustrates a flowchart of a method for an application on a client device implementing requesting and receiving dynamically streamed fonts, according to one embodiment.

FIG. 4 is a flowchart of a method for determining glyphs not currently available to an application on a client device, according to one embodiment.

FIG. 5 is a flowchart of a method for an application on a client device to obtain the definition of a font data structure from a server, according to one embodiment.

FIG. 6 illustrates an example implementation of a font server application, according to one embodiment.

FIG. 7 is a flowchart of a method for an application on a server providing dynamically streamed fonts, according to one embodiment.

FIG. 8 is a flowchart of a method for an application on a server providing a definition of a font data structure, according to one embodiment.

FIG. 9 is a flowchart of a method for incrementally building font data structures, according to one embodiment.

FIGS. 10A, 10B and 10C illustrate creating a font data structure and populating the font data structure with glyphs, according to one embodiment.

FIG. 11 illustrates an example computer system that may be used in various embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Dynamic Streaming of Fonts

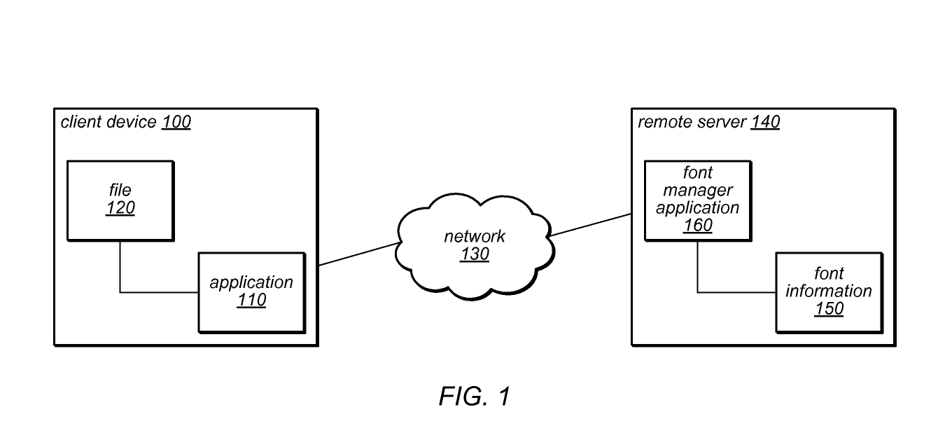

FIG. 1 illustrates a system with a client device and a remote server communicating through a network implementing dynamic streaming of fonts. Application 110 runs on client device 100. Application 110 may be, for example, a word processing application or a web browser. Application 110 may receive a user request to display content from file 120. File 120 may be, for example, a word processing document containing a research paper obtained from Widget Research Company. In some embodiments, file 120 may be created by a user of client device 100, for example by entering text using a word processing application. In other embodiments, file 120 may have been obtained from another device or application (e.g. downloaded from a network server or received as an attachment to an email message). In some embodiments, a user of client device 100 may edit a file received from another device or application to add or modify text (e.g. with a word processing application). File 120 contains characters making up at least a portion of the content. File 120 further specifies a font in which each character in the content is to be displayed. File 120 may, for example, contain the characters “Dynamic Subsets” and specify that the characters are to be displayed in the font “Kigali Std Roman”. Each character in a particular font has an associated glyph that instructs the application how to display the character in the font. Application 110 must have access to the glyph associated with a particular character in order to display the character as specified by file 120. Application 110, then, must determine if it has information about the required glyphs defined in the font “Kigali Std Roman.” As described previously, techniques in the prior art for making glyphs available to an application include installing font description files containing all of the glyphs defined in a font on the client device and embedding font information in the content file itself.

The present invention, dynamic streaming of font subsets, allows application 110 to determine which glyphs defined in a font are currently available to it and to dynamically obtain additional information about only the glyphs required to display a content portion of file 120. Application 110 may analyze content file 120 to determine which particular glyphs are required to display the content (that is, which characters in which fonts). Application 110 may examine other resources on client device 100 to determine which glyphs are currently available to it. In some embodiments of the present invention application 110 may have access to a font data structure containing an arbitrary set of glyphs defined in the font. Font data structures will be described more fully below. In the current example, application 110 may scan content file 110 and determine that the characters “Dynamic Subsets” are to be displayed in the font “Kigali Std Roman”. For the purpose of illustration, application 110 may be assumed to have access to a font data structure for the font “Kigali Std Roman” that contains some, but not all, of the required glyphs. In this example, the glyphs for all of the required characters except “y” and “S” are present in the font data structure. Application 110 may use the glyphs in the font data structure and acquire only the glyphs for the characters “y” and “S” in the “Kigali Std Roman” font from another source.

In some embodiments, the application may format a request message for the required glyphs (the glyphs for “y” and “S” in the present example) and send it through network 130 to remote server 140. In some embodiments, remote server 140 may be the same server from which the application obtained the content document, or remote server 140 may be a server that provides only font information such as glyphs. Remote server 140 receives the message from the application. In response to receiving the message, font manager application 160 executing on server 140 may access font information 150 and determine that font information 150 contains glyphs for the “y” and “S” characters in the “Kigali Std Roman” font. Font manager application 160 may read the glyph information for the characters “y” and “S in the “Kigali Std Roman” font from font information 150, format the glyph information into a reply message and send the reply message through network 130 to application 110 on client device 100.

Upon receiving the reply message from remote server 140, application 110 will have available all of the glyphs required to display the content portion of file 120. Application 110 may use the letters “Dnamic ubsets” from the font data structure for the “Kigali Std Roman” font and the letters “y” and “S” received from the server to display the text “Dynamic Subsets”. In some embodiments, application 110 may further populate a portion of the font data structure with the newly received glyphs (i.e. the glyphs corresponding to the characters “y” and “S” in this example). Should application 110 need to display the characters “Dynamic Subsets” again in the “Kigali Std Roman” font all of the required glyphs will be available to application 110 in the font data structure. In some embodiments a font data structure may be stored in persistent storage, allowing application 110 to continue to have access to glyphs acquired from remote server 140 available to display the same or other content files in subsequent executions. In some embodiments, glyphs obtained by an application from a plurality of servers or from other sources (e.g. content files containing embedded font information) may be stored in the same font data structure in persistent storage. In some embodiments, a font data structure stored in persistent storage may be used by other applications to display content contained in file 120 or to display content portions of other files.

Remote server 140 and client device 100 communicate through network 130. Network 130 may be any wired or wireless network suitable for conveying messages between computers. In some embodiments, network 130 may be the Internet or another wide area network and/or one or more local area networks. In some embodiments, remote server 140 may be a single computer. In other embodiments, remote server 140 may be a plurality of computers that implement one service endpoint as seen from client device 100. In some embodiments, a plurality of computers may be configured as remote server 140 such that one of the plurality of computers receives the request message sent from client computer 100 and another of the plurality of computers sends the reply message containing glyphs.

Client device 100 may be any device able to process a content portion of a file. Typically client devices will have a processor, a means for accessing a communication network and at least one display. Example client devices may include but are not limited to computers, (including but not limited to desktop, notebook and netbook computers) mobile phones, personal digital assistants, portable music players, and digital video recorders. Functionality similar to one or more of the devices listed may be embedded within or added to other products (e.g., automobiles or home appliances) and these products may function as client devices.

In some embodiments, application 110 may not have access to a font data structure for a font required to display the content portion of file 120. This may occur, for example, when application 110 must display characters in a particular font for the first time. In order to obtain a font data structure, application 110 may request a definition for the font data structure from remote server 140. In response to receiving a request for a definition of a font data structure, font manager application 160 executing on remote server 140 may reply to application 110 on client device 100 with a message containing the definition of the font data structure. The definition of the font data structure may allow application 110 to construct a font data structure which initially may be empty (e.g., contain no glyphs). Application 110 may populate this structure with glyphs obtained as described above. In some embodiments, the definition of the font data structure in the reply from remote server 140 may contain one or more glyphs, but less than the entire set of glyphs in the font. In other embodiments, the definition may comprise instructions for constructing a font data structure, the instructions comprising data to write into the font data structure and offsets specifying where in the font data structure the data is to be written. In an embodiment, the request message for a font data structure may also contain requests for one or more glyphs in the font.

### Example Implementation

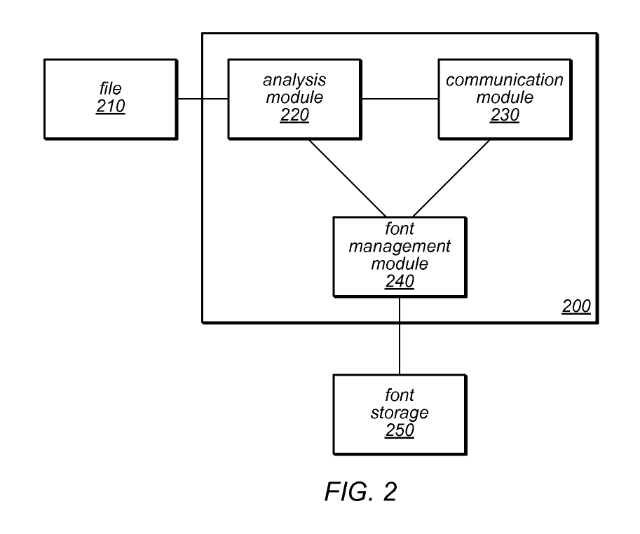

FIG. 2 illustrates an example implementation of an application program on a client device (for example, application 110 on client device 100 in FIG. 1) that may implement dynamic streaming of font subsets. Application 200 contains an analysis module 220, a communication module 230 and a font management module 240. Analysis module 220 may access input file 210 in response to, for example, a user request to open a document or display a web page. Analysis module 220 may analyze file 210 to determine characters (e.g., “A” or “?”) required to display a content portion of file 210 and the font (e.g., Helvetica, Times New Roman, etc.) in which each character is to be displayed. Analysis module 220 may provide as output a list of character/font pairs to font management module 240. In some embodiments, analysis module 220 may analyze file 210 to identify a remote server that may provide glyphs not currently available to application 200. A server may be identified explicitly in content file 210. In some embodiments a server may simply be identified by name (e.g. using a character string embedded in a content file) while in other embodiments a Uniform Resource Identifier (URI) may be inserted into a content file to indicate a resource able to provide glyphs and the particular protocol to be used to access the resource. Those skilled in the art will appreciate that other means for specifying a server to be used for obtaining needed glyphs are possible. In yet other embodiments, a server may be identified by application 200 using indications in file 210 in conjunction with other information. For example, file 210 may contain the name of a content provider in a character string and analysis module 220 may have access to data that specifies a remote server to be used to obtain glyphs for content files from particular content providers. Content providers may be identified using the same means as those for identifying servers in some embodiments, or may be identified using simple names (e.g. “Widget Research Company”) in a appropriate portion of file 210. In some embodiments a content provider may be identified by an arbitrary identifier assigned to the content provider. For example, “Widget Research Company” may be assigned the identifying number “12345” by a provider of a particular font to be used in obtaining glyphs for the particular font from a server operated by the font provider.

Font management module 240 receives character and font information as input from analysis module 220. Font management module 240 determines whether glyphs for any of the character/font pairs in the input information from analysis module 220 are not available to application 200. In some embodiments, font management module 240 consults font data structures to determine whether glyphs are available. In some embodiments, font data structures are stored in font storage 250. In other embodiments, font data structures may be stored in application memory, or in non-volatile memory (e.g., FLASH memory). Font management module 240 may use communication module 230 to obtain, from a remote server, glyphs that are required but not currently available to application 200. Font management module 240 may use glyphs received from a remote server through communication module 230 to populate at least a portion of a font data structure. In some embodiments, based on a reply from a remote server containing a definition of a font data structure, font management module 240 may create an empty or partially populated font data structure.

Communication module 230 may send requests to one or more remote servers and receives responses from the remote servers through a network. In some embodiments, the identification of the remote server may be contained within communication module 230. In other embodiments, the server computer may be identified by analysis module 220, by another module within application 200 or by the client device on which application 200 is running Communication module 230 may format messages as appropriate for the network, and may process received messages into a format suitable for use by other modules of application 200.

It will be obvious to those skilled in the art that architectures for application 200 other than the architecture illustrated in FIG. 2 may be used to implement dynamic streaming of font subsets. Other architectures may practice the present invention by partitioning the functions of the modules described above in other ways or by combining the functions with other functions of application 200 in other configurations of modules.

### Flowchart of an Embodiment of a Client Application

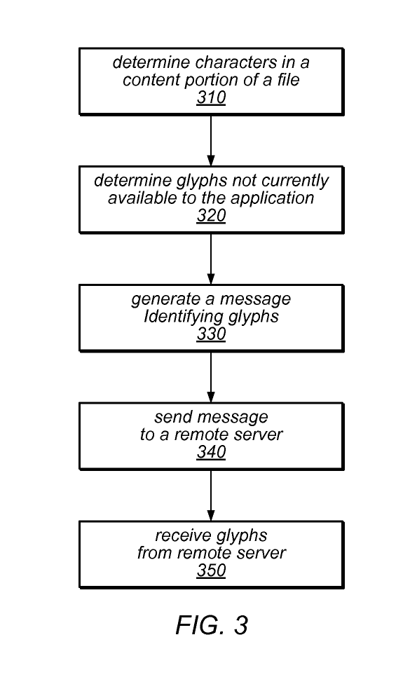

FIG. 3 is a flowchart of an embodiment of a method that an application program, for example application 200 illustrated in FIG. 2, may use to implement dynamic streaming of font subsets. The method begins in 310 with an application on a client device analyzing a content portion of a file to determine characters and fonts required to display the content. For example, a word processing application may analyze a content portion of a file in response to a user request to edit the file or a web browser application may analyze a web page (i.e. an HTML file) downloaded from a web site in order to display the page. In either of these examples the application (word processor or web browser) may need to display characters is a particular font specified by the content file being opened. Displayable files may include documents stored on the client device (e.g. word processing or presentation files), files obtained from a server (e.g. web pages in HTML format that are typically displayed by web browser software), multimedia content that includes animations in addition to text and static graphics (e.g. Adobe Flash files), or any other file with content that may be displayed and that contains character and font information. In some embodiments, displayable files may contain content entered by a user of a client device (e.g. typing text into a document with a word processing application) or generated by an application executing on a client device (e.g. text automatically generated by an application). The analysis may process text in the content portion of the file, recording information indicating each character that is required to display the text and the font in which each character is to be displayed as specified by the file. This information may be stored in a suitable data structure (e.g., a list of required characters in each font).

In step 320, the application determines whether it currently has access to the glyphs required to display the characters in the fonts required by the content portion of the file. The application may search the glyphs available to it for each character, in the required font, that was determined in 310. The application may, in some embodiments, search several locations for glyphs. It may, for example, search the set of font files installed on the client device for a file defining the required font. It may also search the file containing the content for embedded fonts or font subsets. The application may also search font data structures, as described below, that have been created by the application or by other applications. The application identifies the glyphs not currently available to it. The identified glyphs are less than the entire set of glyphs defined by the font. Were the application to determine that all of the glyphs defined by a font were required, the application would need an entire font definition file and no dynamic subset of the font would need to be created. In step 330, in order to request the needed glyphs, the application generates a message containing identification of the glyphs determined in step 320. In some embodiments the message may contain information in addition to the glyph identification. Additional information may include identification of one or more of the application, the client device, the content file, a provider of the content file, a network hosting domain of a provider of a content file, or the author of the content file. In step 340, the message is sent to a remote server which can provide the needed glyphs. The remote server to which the message is sent may be determined in one of several ways. In some embodiments the client device may be configured to send messages identifying required glyphs to a particular remote server. In other embodiments an application program displaying content may be configured to send requests to a particular remote server. In yet other embodiments, the file containing the content may specify a remote server, or the file may identify the content provider or content author and the application may select the remote server based on the provider or author information. It will be clear to those skilled in the art that the remote server may be determined using combinations of these methods. For example, an application may be configured to use a particular remote server for content files that do not specify a remote server.

In step 350, in response to the message sent in step 340, the application receives glyphs from the remote server. The glyphs received comprise the glyphs determined to be required in step 320 and identified in the message generated in step 330. As described previously, the glyphs received will be less than all of the glyphs defined in the font. In some embodiments, the application may receive the glyphs from a remote server other than the remote server to which the message was sent in 340. For example, a supplier of fonts may use one server to receive incoming request messages while using various other servers to store and supply particular fonts. In another embodiment, the request may be sent to a server operated by the provider of a content file and the provider may arrange to have glyphs delivered in a message from a server operated by a font supplier.

In some embodiments, the application may use the glyphs received in step 350 to populate at least a portion of a font data structure. A font data structure contains information that a device uses to display glyphs defined in a font. This information may include information about the font generally (e.g., font metrics), instructions for drawing the outlines of glyphs, and additional information about individual glyphs (e.g. dimensions of the glyph bounding box, or space that pads the glyph outline on either side). A font data structure may contain all of the glyphs defined by a particular font, it may contain none of the glyphs defined by the font, or it may contain some but not all of the glyphs defined by the font. The data for a particular glyph may be in one or more of several forms. Glyphs may be described in terms of mathematical expressions. For example, in PostScript Type 1 and related fonts, glyphs may be described with cubic Bézier curves. In TrueType fonts, glyphs may be described with quadratic curves. In other font systems glyphs may be represented by bitmaps of one or more sizes.

A font data structure may also contain structural information about the font data structure itself (e.g., a map indicating where within the font data structure information for a particular glyph is located). A font data structure that contains none of the glyphs defined in the font may still contain structural information about the font data structure itself. The definition of a font data structure provides information to allow an application to create an empty, or shell, font data structure. An empty font data structure contains no glyphs, but it has any needed internal structure to allow glyphs to be added and to allow the data structure to be searched for glyphs. In some embodiments, the definition of a font data structure may additionally contain one or more glyphs less than all glyphs defined in the font. Font data structures may be, but are not necessarily, stored in files on disk drives attached to a client device. Font data structures may alternatively be stored in storage accessible through a network, on removable storage media (e.g. a USB thumb drive), or in volatile (e.g. RAM memory) or non-volatile (e.g. FLASH memory) memory. In some embodiments, a font data structure may be stored as part of the memory of a particular application. Font data structures may comprise text data (e.g. using ASCII characters), binary data, or a combination of text and binary data. Text data may be in the form of text easily readable by people, or it may be a textual representation of binary data. Font data structures may be wholly or partially encrypted.

Accumulating Glyphs from Multiple Requests

In some embodiments, the steps illustrated in FIG. 3, including the additional step of storing received glyphs in a font data structure, may be repeated by an application. The application may repeat these steps for different portions of the content file, for example for individual pages or screens of content as they are displayed. The application may also repeat these steps using content portions of different files in step 310. The different files may come from the same or different content providers. Repetition of the steps may take place within one or more than one execution of the application. Subsequent repetitions may add additional glyphs to the font data structure. When the font data structure for a font is stored in persistent storage (e.g. a disk drive or FLASH memory) the application may accumulate currently available glyphs for the font.

In some embodiments, a plurality of applications on a client device may share a font data structure. Each one of the plurality of applications may use the font data structure to access currently available glyphs, and each application may store glyphs received from a remote server into the font data structure.

In some embodiments, subsequent repetitions of steps 340 and 350 may use different remote servers to obtain glyphs for a font. For example, two different content files may specify different servers from which to obtain glyphs from the same font. Glyphs received from different remote servers for the same font may be used to populate a single font data structure for the font. Subsequent repetitions may be performed by a single application in one or more executions of the application, or the repetitions may be performed by a plurality of applications.

In some embodiments, glyphs may be obtained by means other than being received from a remote server. For example, an application may obtain glyphs from files that contain some but not all of the glyphs defined in a font. Such files may be content files with embedded glyphs, or files with no content containing a subset of glyphs in a font. Files containing glyphs may be obtained in a variety of ways including, but not limited to, downloading from a server through a network, or loading from a CD-ROM or USB thumb drive. Glyphs for the same font obtained from different sources may in some embodiments be used to populate a single font data structure for the font. Glyphs in a font obtained by different applications, from either one or more servers or from other sources, may be used to populate a single font data structure for the font.

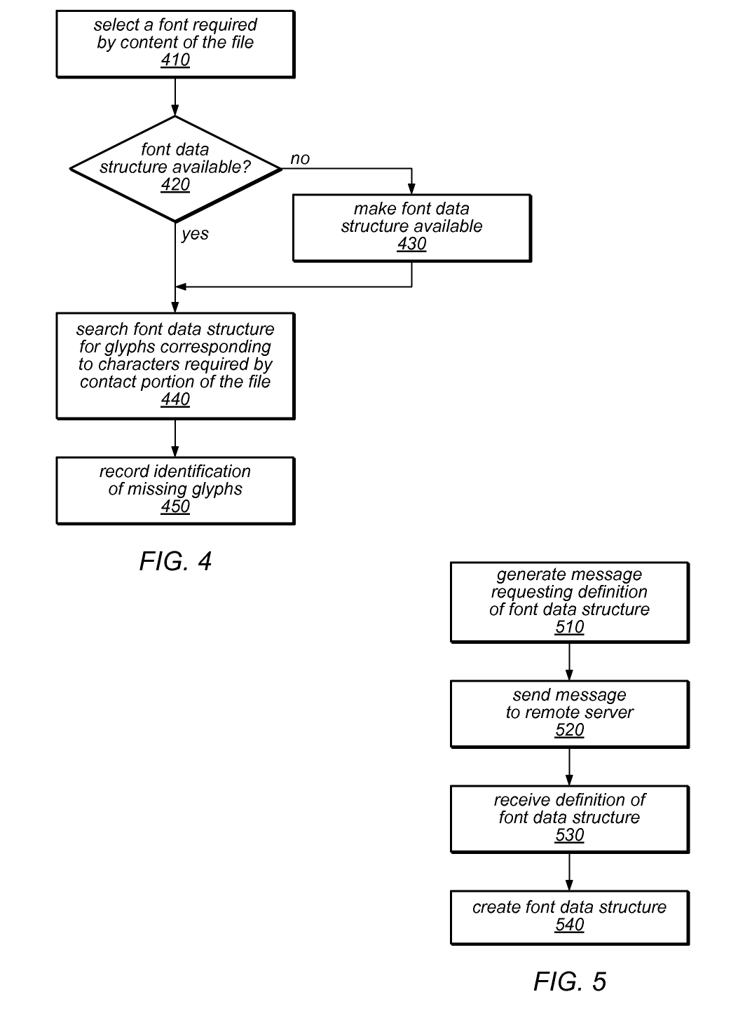

FIG. 4 is a flowchart of an embodiment of steps that an application may take to determine whether glyphs are available to the application as in step 320 of FIG. 3. A content portion of a file may require more than one font. In step 410, one font from among the fonts required by the file is selected to examine. In step 420, the application determines whether a font data structure is available for the font. When the application determines that a font data structure for a particular font is not available to the application it may take steps to make a font data structure available before proceeding as in step 430. One embodiment of steps to make a font data structure available is illustrated in FIG. 5 and described below. In other embodiments, the application may take actions other than making a font data structure available. Other actions may include, in various embodiments, informing the user that a font data structure is unavailable, displaying characters that require the font using a substitute font, not displaying characters that require the font, or not displaying the content portion of the file.

In step 440, the application has determined that a font data structure for the font is available and searches the font data structure for glyphs corresponding to the characters, in the particular font, required by the content portion of the file (as determined in step 310). In step 450, the application records identifying information (e.g. the numeric character code and the name of the font) for required glyphs that are missing from the font data structure. This identifying information may be used in the generation of a message to request the glyphs from a remote server (as in step 330).

The steps in FIG. 4 may be repeated, in various embodiments, to identify glyphs in a plurality of fonts. For example, the word processing document described earlier may require a custom font “ContentProviderCustomFont” in addition to “Kigali Std Roman”. In some embodiments the identifying information recorded as in step 450 for several fonts may be combined. The steps may also be repeated for a particular font. For example, the steps may be repeated by the application in order to display another content portion of the file (e.g. another page or screen of the content file) or to display a content portion of another file. The steps may be repeated when the content portion of a file changes, for example during an editing operation on the file. The identifying information recorded in step 450 may be appended to information recorded during previous repetitions or information from multiple repetitions may be recorded separately.

FIG. 5 illustrates an embodiment of steps that an application may take to create a font data structure when no font data structure for a required font is available, as in step 430 of FIG. 4. In step 510, after having determined that no font data structure is available for a font required by a content file, the application may generate a message requesting a definition of the font data structure. In some embodiments, the message may contain a name for the font (e.g. “ContentProviderCustomFont” as in the example above). In other embodiments the message may contain, in addition to or in place of a font name, another identification of a font. Such identification may be, for example, an arbitrary identifier (e.g. sequence of characters “ABC123” or numeric value 123456) provided in the content document by the content provider. In some embodiments, in addition to identifying a font, the request may contain additional information associated with the client device (e.g. a serial number for the client device, an identification of the operating system on which the application is executing or a version code for the application itself). The message may be formatted for communication to the remote server, in some embodiments by a module such as communication module 230 in FIG. 2. In step 520, a remote server is determined and the generated message is sent to the remote server. The remote server to which the message is sent may be determined by any of the methods described above for determining the remote server to which messages requesting glyphs are sent. The method for determining a remote server in step 520 need not be the same method used to determine a remote server in step 340. Messages requesting glyphs and messages requesting definitions of font data structures may be sent to the same remote server or to different remote servers, in various embodiments. For example, in some embodiments, a content file may specify a server to be used to obtain glyphs while the application may be programmed to obtain font data structures from the server of a trusted font provider.

In step 530, in response to the request message sent in step 520, a reply message containing a definition of the font data structure is received from the remote server. In some embodiments the remote server providing the reply message may be a different server than the one to which the request message was sent. For example, a font provider may designate a single server for receiving requests and maintain separate font servers for providing information about particular fonts. The single server receiving requests may forward requests for a particular font to the font server for the particular font. The definition information provided by a remote server may take different forms in various embodiments. In an embodiment, the definition may comprise data in a plurality of data blocks and corresponding location information specifying the location of the data blocks in the font data structure. The application may write the blocks into storage according to the location information to create a font data structure. In another embodiment the definition may comprise a font data structure contained in a single block of data. In step 540 the application uses the definition supplied by the remote server to create a font data structure. In some embodiments, the font data structure created in 540 using the definition received in 530 contains no glyphs. In another embodiment, the newly created font data structure contains some but not all of the glyphs defined by the font.

Requesting a definition of a font data structure and receiving the definition for a font data structure may be implemented through means other than the steps illustrated in FIG. 5. In some embodiments, an application may generate a request for a definition of a font data structure for a font and include it in a request message for glyphs from the font as in step 340. A font data structure definition requested in this manner may be received in a message that also contains glyphs as in step 350, or the font data structure definition may be received in a separate message. In some embodiments, an application may acquire a font data structure for a font from a source other than a remote server. In some embodiments, a font data structure may have been created by a previous execution an application. In other embodiments, a font data structure may be obtained through explicit user action (e.g. downloading a font data structure from a font provider, through a web page or other suitable means) or from a storage medium such as a CD, a DVD or a USB thumb drive. In some embodiments, a font data structure may be installed on a client device by, for example, the device manufacturer for use by applications running on the device.

### Font Server

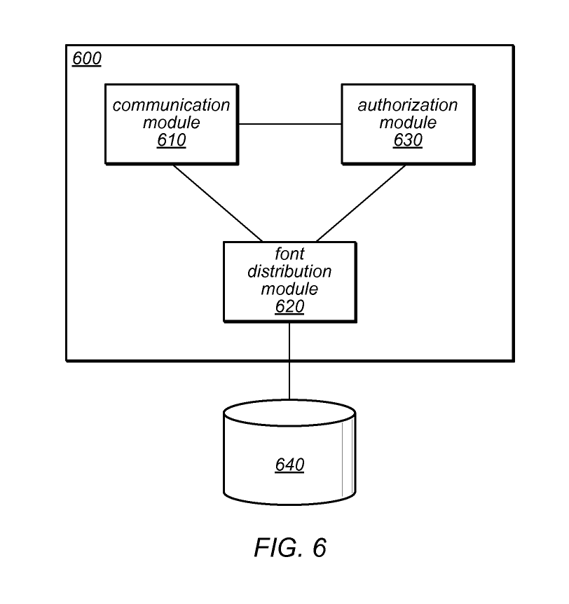

FIG. 6 illustrates an example implementation of a font manager application on a server implementing dynamic streaming of font subsets (for example, font manager application 160 executing on remote server 140 as illustrated in FIG. 1). Font manager application 600 in FIG. 6 executes on a server computer, receiving requests from applications executing on client devices for glyphs of fonts. An application on a client device may, in some embodiments, generate a request for glyphs in response to a user request to display content from a file. In response to receiving a request for one or more glyphs, font manager application 600 parses the request to determine the requested glyphs, retrieves glyph information for the requested glyphs from font storage 640, generates a reply message containing the requested glyphs (but fewer than all of the glyphs defined in the font) and sends the reply message containing the glyphs to the requesting application on a client device. As illustrated in FIG. 6, font manager application 600 comprises communication module 610, font distribution module 620 and authorization module 630. Communication module 610 receives requests for glyphs from applications on remote client devices, typically through a network, and communicates the requests to font distribution module 620. In some embodiments, communication module 610 may receive requests from applications executing on client devices for definitions of font data structures. In some embodiments requests for definitions of font data structures will be sent by applications on client devices the first time that the application needs to display glyphs in a particular font. Communication module 610 communicates requests for font data structures to font distribution module 620. Communication module 610 receives glyph information from font distribution module 620. In some embodiments, communication module 610 receives definitions of font data structures from font distribution module 620. Communication module 610 formats glyphs and, in some embodiments, definitions of font data structures into reply messages suitable for transmission over a network and sends the messages to applications executing on remote client devices. In some embodiments, communication module 610 may send and receive messages to authorization servers on behalf of authorization module 630.

Font distribution module 620 receives requests for glyphs of a font from application programs executing on remote client devices through communication module 610. In some embodiments, font distribution module 620 parses the request in order to determine the requested glyphs. Glyphs requested by application programs may be less than all of the glyphs defined in a font. In some embodiments, a request for all of the glyphs defined in a font may result in font distribution module 620 providing an entire font definition file. In order to fulfill a request for one or more glyphs, less than all of the glyphs defined in a font, font distribution module 620 accesses a font data store on font storage 640 to obtain glyph information. Font distribution module 620 extracts the requested glyphs from font storage 640 and formats the requested glyphs for use by an application on a remote client device. In some embodiments, font storage 640 may contain complete font definition files suitable for installation on client devices as known in the art. In such embodiments, font distribution module 620 may extract portions of the font definition file corresponding to the requested glyphs and provide the portions to the remote application. In other embodiments, font storage 640 may contain glyphs in a format other than a font definition file. For example, a font data store on font storage 640 may be implemented using database software (e.g. a relational database system such as mySQL). In some embodiments, font storage 640 may contain some but not all of the glyphs defined in a font. For example, font storage 640 may be implemented as one node in a distributed database system configured such that the multiple storage nodes each store a portion of the glyphs defined in a font. Font distribution module 620 provides the formatted glyphs to communication module 610 for formatting into a message and transmission to an application on a remote client device. In some embodiments, font distribution module 620 may receive requests for definitions of font data structures from remote applications through communication module 610. In some embodiments, remote applications may generate requests for a definition of a font data structure in response to a user request to display a document. In some embodiments, font distribution module 620 may analyze data contained in font storage 640 to create definitions for font data structures. The definitions may be provided to communication module 610 for formatting into messages and transmission to remote applications.

Authorization module 630 may be used, in some embodiments, to determine whether a request received by communication module 610 should be fulfilled by font distribution module 620. Authorization module 630 may examine information contained in a request to make a determination on fulfilling the request. Information contained in a request message that authorization module 630 may use, in some embodiments, comprises the particular fonts or glyphs requested, an identification of the application executing on the client device which sent the request, an identification of a network domain from which a document was obtained by the client and an identification of a content provider for a document available to the application. Additional information (e.g. a list of authorized applications or content providers) may be used by authorization module 630 to make the determination. Continuing the example given earlier in regard to FIG. 1, authorization module 630 may examine a request message identifying Widget Research Company as the content provider for a document specifying characters to be displayed in the font “Kigali Std Roman”. Authorization module 630 may consult a list of content providers and the fonts that particular content providers may use. In this example, the content provider list may show Widget Research Company as an authorized user of the font “Kigali Std Roman” and authorization module 630 may inform font distribution module 620 to generate a reply message in response to the request. Should the content provider list fail to include Widget Research Company, authorization module 630 may inform distribution 620 to ignore the request. In some embodiments, authorization module 630 may communicate with other applications or systems through communication module 610 to acquire information to make the determination. A list matching content providers with fonts may, for example, be maintained on another server accessible through a network rather than within application 600.

It will be obvious to those skilled in the art that architectures for font manager application 600 other than the architecture illustrated in FIG. 6 may be used to implement dynamic streaming of font subsets. Other architectures may practice the present invention by partitioning the functions of the modules illustrated in FIG. 6 in other ways or by combining the functions with other functions of font manager application 600 in various configurations of modules.

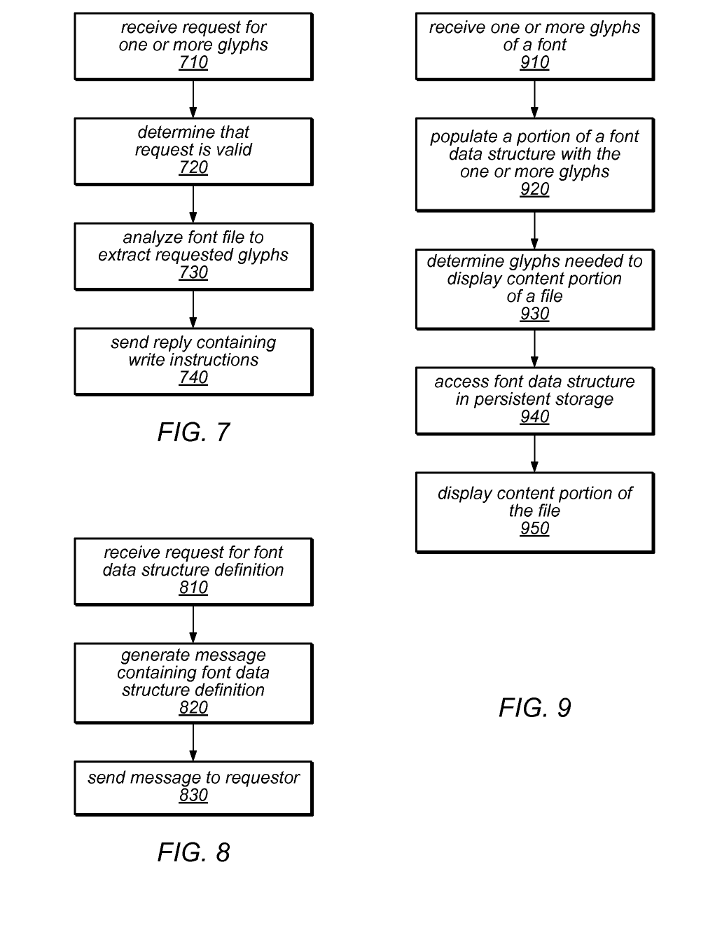

FIG. 7 illustrates an embodiment of steps that a server application, as illustrated in FIG. 6, may take to dynamically stream font subsets. In step 710 the server application receives a request message for one or more glyphs in a font. The request message may be received in various ways. Typically it will be received through a network (for example, through communication module 610) from an application program executing on a remote client device. In some embodiments, the remote application generates a request in response to a user request to display content such as a document or web page. In some embodiments, the server parses the request message to determine the one or more glyphs identified in the request message. The glyphs requested may be fewer than all of the glyphs in the font. A request for all of the glyphs of a font may be fulfilled, in some embodiments, by sending an entire font definition file. In step 720 the server application determines that the request is valid and that the request for glyphs should be fulfilled. Determining that the request is valid may include verifying that the glyphs requested are defined by the font, and that the font itself is a font that the server can provide. Requests for glyphs that a server cannot provide may be received due to, for example, an incorrectly formatted document that requires characters not defined in a particular font, or a remote application (e.g. application 110 in FIG. 1) configured to send request messages to a server that cannot provide the needed font. Verifying that the server can provide the glyphs requested may be done, in an embodiment, by a module of the application such as font distribution module 620 in FIG. 6. In some embodiments, a server may reply to a request from a remote application for one or more glyphs that the server cannot provide with a message indicating that the server application received the request but cannot provide the glyphs. In some embodiments, the server application may further determine whether the application executing on the client device is authorized to receive the requested glyphs (for example, with a module such as authorization module 630 illustrated in FIG. 6). In some embodiments, determining whether the application is authorized may include examining information contained in the request message. Such information may comprise an identification of the client device, of the application making the request, of the content file containing characters corresponding to the requested glyphs, of the content provider or of the content author. The server application may use additional information, not contained in the request message, to determine whether a request should be fulfilled. For example, the server application may consult a database identifying fonts to be made available in response to requests identifying particular content providers. The server application may communicate with one or more other servers to determine whether an application is authorized to receive the requested glyphs.

In step 730, the server application (e.g. using font distribution module 620 as illustrated in FIG. 6) analyzes font information, typically residing on storage accessible to the server (e.g. font storage 640), to extract the requested glyphs. In some embodiments, data representing the glyphs is read from a font distribution file. Other embodiments may store glyph data using a database system (e.g. a relational database system such as mySQL) or using any other suitable means for organizing and storing data known in the art. The extracted glyphs may not be in a form immediately useful to the requesting remote application, so in some embodiments the glyphs may be formatted for use by the requesting remote application. In some embodiments, formatting the glyphs may include placing each glyph into a data block and determining the offset in a font data structure for the font at which the data block must be written by the requesting application. In other embodiments, the glyphs may be sent in a single data block. In some embodiments, additional information may be included in the formatted information (e.g. instructions to modify structural information contained in a font data structure). In step 740, the formatted glyphs are formatted into a message suitable for transmission and sent to the requesting application (for example by a module such as communication module 610).

In some embodiments, request messages for glyphs received in step 710 may contain requests for glyphs from more than one font. Some or all of steps 720 and 730 may be repeated for each font identified in a request message. Glyphs may be sent to the requesting remote application in step 740 in a single message, or step 740 may be repeated to send the glyphs in a plurality of reply messages. In some embodiments, glyphs in a single font may be sent in a plurality of reply messages. For example, a reply containing a large number of complex glyphs may be split into a plurality of smaller messages. In some embodiments, the steps illustrated in FIG. 7 may be performed using a plurality of servers. For example, all requests in 710 may be directed to a first server. The first server may assign a request to one of a plurality of reply servers and the assigned reply server may then provide the glyphs to the requesting remote application. In some embodiments, the first server may assign a request to a reply server for a particular font identified in the request message or to a reply server geographically close to the remote application. In some embodiments, a single request may be assigned to a plurality of servers, and each of the plurality of servers may reply providing different ones of the requested glyphs. Those skilled in the art will appreciate that other configurations of servers replying to request messages are possible in addition to the examples provided here.

FIG. 8 illustrates an embodiment of steps that a server application may take to provide a definition of a font data structure. A request for a definition of a font data structure may be received from a remote application displaying content in a font never before used by the remote application following, for example, the steps illustrated in FIG. 5. In step 810 the server application receives a request from a remote client application for a font data structure definition. The request may be received by various means. Typically the request will be contained in a message received through a network (e.g. by a module such as communication module 630 illustrated in FIG. 6). In some embodiments the request may be a separate message received by the server application, while in other embodiments the request may be received in a message that contains other elements (e.g. a request for glyphs in a font). In step 820 the server application generates a message containing a font data structure definition. In some embodiments, a module such as font distribution module 620 may generate instructions for creating a font data structure. In some embodiments the application may have a pre-defined font data structure definition available for one or more fonts. In other embodiments the application may analyze font data accessible to the server (e.g. a font definition file or a database stored in font storage 640 as in FIG. 6) to create a font data structure definition in response to the particular request. Typically a font data structure created using a font data structure definition will be empty (i.e. will contain no glyphs), however in some embodiments a newly created font data structure created will have glyphs, less than all glyphs defined in the font. In step 830 the application formats the font data structure definition for transmission and sends it to the requesting remote client application. The font data structure may be sent to the requesting remote client application in a message with no other information, or it may be sent in a message containing other data (e.g. glyphs from a font).

### Incrementally Building Font Data Structures

Font data structures may provide a mechanism for allowing a device to acquire glyphs for a font as the glyphs are needed to display content files by one or more applications (e.g. word processing documents or web pages). Further, a device may store acquired glyphs for subsequent use by storing font data structures in persistent storage. As discussed previously, font data structures may contain data for all of the glyphs defined in a font, for none of the glyphs defined in a font, or for some but not all of the glyphs in a font. Font data structures stored in persistent storage (e.g. non-volatile Flash memory, hard disk drives, or battery backed-up RAM) may allow applications on a client device to use glyphs acquired to display characters in a font as specified by a content document to be used to display other content documents that specify one or more of the same characters in the same font. An application displaying the other content document may access an existing font data structure in persistent storage and use one or more glyphs stored in the font data structure. The other content document, however, may require other glyphs not currently available in the font data structure. These other glyphs may be obtained (e.g. from a remote server) before the other content is displayed. Once the other glyphs are obtained the application may use them to populate additional portions of the font data structure in persistent storage. Thus the other glyphs become available to display further content documents on the client device.

In the example discussed previously in connection with FIG. 1, a device displaying a first content document had access to a font data structure containing all but two characters required to display the words “Dynamic Subsets” in the “Kigali Std Roman” font. The glyphs for the characters “y” and “S” were acquired from a remote server. The application may populate the “Kigali Std Roman” font data structure in persistent storage with the glyphs corresponding to the “y” and “S” characters, and subsequent executions of the application may be able to display the words “Dynamic Subsets” without needing to acquire any further glyphs. Extending the previous example, another content document may contain the words “Dynamic Font Subsets” and specify that the characters be displayed in the “Kigali Std Roman” font. In some embodiments, the other content document may be created by a user on a client device editing the first content document, or by a user creating a new content document containing the words “Dynamic Font Subsets” (for example, by entering text using a word processing application). Another execution of the application may access the font data structure, analyze the other content document, and determine which glyphs are required but not currently available in the font data structure. In this example, the words “Dynamic” and “Subset” occur in the other content document, as in the first content document. The other content document also contains the word “Font”. The glyphs corresponding to the letters “n” and “t” are currently available in the font data structure as they were required to display the words “Dynamic Subset” in the first content document. The characters “F” and “o” were not required to display the first content document. In this example, they are not present in the font data structure. The application may acquire glyphs corresponding to the “F” and “o” characters using, for example, the means previously described. After acquiring only the two additional glyphs corresponding to the characters “F” and “o” the other content document may be displayed.

The application may populate the font data structure in persistent storage with the glyphs corresponding to the “F” and “o” characters. A further execution of the application needing to display the words “Dynamic Font Subsets” using the “Kigali Std Roman” font may have all of the needed glyphs currently available in the font data structure and not need to acquire any further glyphs. To continue with the example, the application may display further content that uses the characters in the words “Dynamic Font Subsets” in the “Kigali Std Roman” font without acquiring further glyphs. Since all of the characters in the words “Fun times” appear in the words “Dynamic Font Subsets” an application may, in this example, display the words “Fun times” in the “Kigali Std Roman” font with the glyphs currently available in the font data structure in persistent storage. By repeatedly acquiring glyphs through these means, one or more applications on a client device may dynamically build a collection of glyphs particular to the client device. The particular glyphs present on any client device may depend on the particular documents that have been displayed on the client device.

FIG. 9 is a flowchart illustrating an embodiment of incrementally building font data structures in persistent storage as described above. In step 910, a device receives one or more glyphs defined in a font. In an embodiment, an application may perform steps 310 through 340 in FIG. 3 in response to a user request that the application display a content portion of a file, receiving glyphs from a remote server as in step 350. In other embodiments, other means of receiving glyphs may be used by a device. For example, glyphs may be embedded in a content file and receiving the glyphs may comprise reading the glyphs from the file. In other embodiments, a device may receive glyphs asynchronously with respect to displaying a content document. For example, a user may locate a font description file that contains a subset of glyphs, less than all of the glyphs defined in the font. Such a font description file may be stored locally or may be available through a network. In still other embodiments an application may search, on local storage or through a network, for files or other resources that may contain glyphs. In some embodiments an application, or other modules on behalf of an application, may perform such a search in response to a user request to display the content portion of a document.

In step 920, the device populates at least a portion of a font data structure in persistent storage with the received glyphs. In some embodiments a user may direct the device to populate a font data structure with glyphs or authorize an application to populate the font data structure. In other embodiments an application may populate the font data structure without user intervention. In some embodiments the font data structure may have been created following the steps illustrated in FIG. 5. In some embodiments, the font data structure may contain one or more glyphs of the font prior to the populating of step 920. In other embodiments, the font data structure will be empty before it is populated with glyphs in step 920. The exact method of populating the font data structure depends on the implementation details of the font data structure and the format of the received glyphs. Various techniques for inserting received data into data structures are well known to those skilled in the art.

In step 930, glyphs needed to display a content portion of a file are determined on behalf of an application. In some embodiments this may be done in response to a user request. For example, a user may request that a word processing application display a document file or that a web browser display a web page (e.g. an HTML file). As described above, a content portion of a file may contain characters and the file may specify that the characters are to be displayed in a particular font. In order to display a character in a font, a glyph for the font corresponding to the character must be available. In some embodiments, an application may analyze the file to determine the glyphs required to display a content portion of a file. In other embodiments the determining may be done by another module (e.g. an operating system module) on behalf of an application.

In step 940 the font data structure in persistent storage is accessed. The application, or another module on behalf of the application, may find the determined glyphs in the font data structure and use the glyphs to display the content portion of the file, as in step 950. One or more of the determined glyphs used by the application may, in some embodiments, be the glyphs that were used to populate the font data structure in step 920. Others of the determined glyphs may have been present in the font data structure in persistent storage prior to populating the data structure as in step 920.

In some embodiments, an application may require other glyphs not present in the font data structure in persistent storage in order to display a content portion of a file. An application may receive the other glyphs through a variety of means. For example, an application may send a request identifying the other glyphs and receive the other glyphs from a remote server following steps 320-350 as illustrated in FIG. 3 and described above. In other embodiments, the other glyphs may be received from a file (e.g. the file containing the content). In some embodiments, the application, or another module on behalf of the application, may store the other glyphs into a font data structure in persistent storage. Once stored in a font data structure, the other glyphs may be available to the application, or to other applications, to display content files. Glyphs for the same font obtained from multiple sources (e.g. from more than one remote server, or from a remote server and a file) may be stored in the same font data structure in persistent storage.

In some embodiments, a plurality of applications, or other modules on behalf of the plurality applications, may access a font data structure in persistent storage either sequentially or concurrently. In some embodiments, a plurality of applications, or other modules on behalf of the plurality applications, may populate various portions of a font data structure either sequentially or concurrently. Techniques for controlling concurrent updates to data structure or files, well known to those skilled in the art, may be used to prevent concurrent accesses to the font data structure from interfering with each other as. In some embodiments, an application may access glyphs in the font data structure that were stored by another application, by a module on behalf of another application, or by a module not on behalf of any particular application.

In some embodiments, a device may create a font data structure in persistent storage. For example, a user may request a web browser to display a web page that may specify characters to be displayed in a new font, or in an older font that the device has never used. A device following steps similar to those illustrated in FIG. 4, for example, may determine, as in step 420, that no font data structure is available and may make a structure available, as in step 430, by creating one. The device may then populate the created font data structure with glyphs and access it as illustrated in FIG. 9 and described above. In some embodiments, the device may create a font data structure by generating a message identifying the font data structure, sending the message to a remote server, and receiving a definition of the font data structure from the remote server, as illustrated in FIG. 5. The device may then use the definition received from the remote server to create the font data structure. In an embodiment, a font data structure may be created in response to determining on behalf of an application that glyphs for a particular font are required to display a content portion of a document and that the device possesses no font data structure for the particular font.

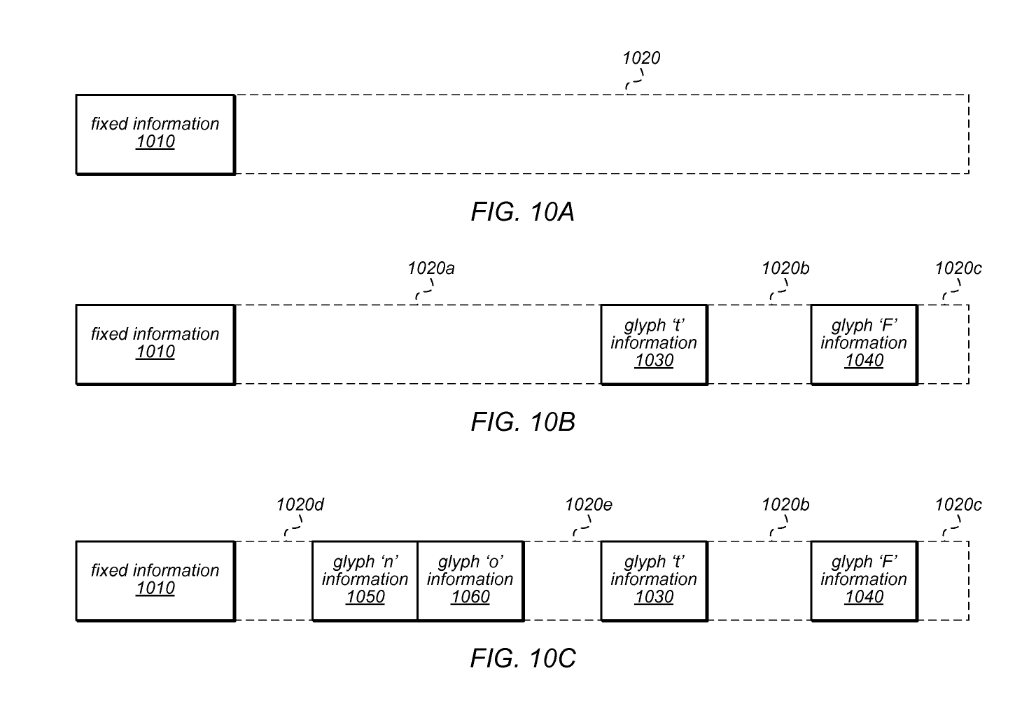

FIGS. 10A, 10B and 10C illustrate an embodiment of populating a font data structure with glyphs as illustrated in FIG. 9. The font data structure used in this illustration has a fixed portion that must be present and a variable portion that may be completely absent, partially present or completely present. The fixed portion in this example may contain information about the layout of the font data structure (e.g. a map to the contents of the data structure) and it may contain information about the font as a whole (e.g. font metrics). The variable portion contains information about individual glyphs. This structure is for illustrative purposes only and not intended to be limiting. Those skilled in the art will appreciate that other organizations of font data structures consistent with the present invention are possible.

FIG. 10A illustrates an embodiment of an empty font data structure (i.e. a font data structure containing no glyphs). An empty font data structure may be constructed by an application using definition information obtained from a remote server, as illustrated in FIG. 5, or it may be obtained by other means as described above. Fixed information 1010 represents information that was provided by the definition of the font data structure and, in this embodiment, remains constant. Empty portion 1020 represents the full extent of the font data structure if it were to be fully populated with glyphs. In some embodiments empty portion 1020 may not occupy persistent storage, with storage space allocated only as glyphs are added. In other embodiments, entire empty portion 1020 may be assigned storage locations in persistent storage when the empty font data structure is created.

FIG. 10B illustrates the font data structure of FIG. 10A after two glyphs have been added. For example, a word processing application may need glyphs to display a document file containing the abbreviation “Ft” in the font corresponding to the font data structure illustrated. Fixed information 1010 remains unchanged in this example. Glyph information portions 1030 and 1040 (corresponding to the characters “t” and “F”) have been added by an application performing, for example, steps 910, 920 and 930 as illustrated in FIG. 9. Empty portion 1020 illustrated in FIG. 10A has been divided into smaller empty portions 1020a, 1020b and 1020c by the insertion of glyph information portions 1030 and 1040. An application accessing the font data structure may have a means to determine whether a particular glyph is present. In this illustration, each glyph defined in the font has a pre-determined location in the font data structure. If the glyph is currently available in the font data structure it will be available at the predetermined location. If a glyph is not currently available, a way to indicate the absence of the glyph may be provided. In some embodiments, empty portions 1020a, 1020b and 1020c may be allocated in persistent storage and filled with a distinctive pattern that the application recognizes as indicating that a glyph is not present. Attempts to access a glyph that, if present, would occupy one of the empty portions 1020a, 1020b or 1020c return the distinctive pattern and the application recognizes that the glyph is absent. For example, empty portions may be filled with bytes with the value ‘0’ and portions populated with glyph information may begin with a byte with the value “1”. In other embodiments, empty portions 1020a, 1020b and 1020c may not be allocated in persistent storage and an attempts to access a glyph that, if present, would occupy one of the empty portions 1020a, 1020b or 1020c may cause an error condition (e.g. a segment violation exception) that may indicate to the application that there is no glyph present.

Those skilled in the art will appreciate that other implementations of font data structures consistent with the present invention may provide other means to determine whether particular glyphs are currently available. In some embodiments, for example, a font data structure may contain a table indicating the presence or absence of particular glyphs. The table may have a pre-determined entry for each glyph in the font, and the table entry for a glyph may be updated when a glyph is added to the font data structure. An application may determine whether a glyph is present in the font data structure by accessing the table. In some embodiments, a font data structure may also indicate that a particular glyph is not available. A particular glyph may be marked as not available, for example, when a previous request has been made for the glyph and a remote server has indicated that the glyph is not available. In some embodiments, a glyph that is marked as not available may not be requested from a remote server, thereby avoiding repeated requests for unavailable glyphs.

FIG. 10C illustrates the font data structure of FIG. 10B after it has been further populated with additional glyphs by another execution of an application (for example, a word processing application receives a user request to display another document file, the other file containing the word “Font” in the font corresponding to the font data structure). Glyphs have been added in glyph information portions 1050 and 1060 (corresponding to the characters “n” and “o”), occupying contiguous locations in the font data structure. Empty portion 1020a of FIG. 10B has been partially occupied by glyph information portions 1050 and 1060, leaving empty portions 1020d and 1020e. Glyph information portions 1030 and 1040, containing glyphs corresponding to the characters “t” and “F”, along with empty portions 1020b and 1020c remain unchanged.

An application may display a content portion of a file without adding additional glyphs to a font data structure. The application may determine that all of the needed glyphs are currently available in a font data structure and that the application has no need to obtain additional glyphs. For example, a word processing application may display the words “not”, “no”, “on” and “to” in the font corresponding to the font data structure illustrated in FIG. 10C without obtaining any additional glyphs. As one or more applications incrementally add glyphs to a font data structure an increasing number of glyphs will be currently available to the applications and fewer additional glyphs may need to be added in order to display new content files.

### Example System

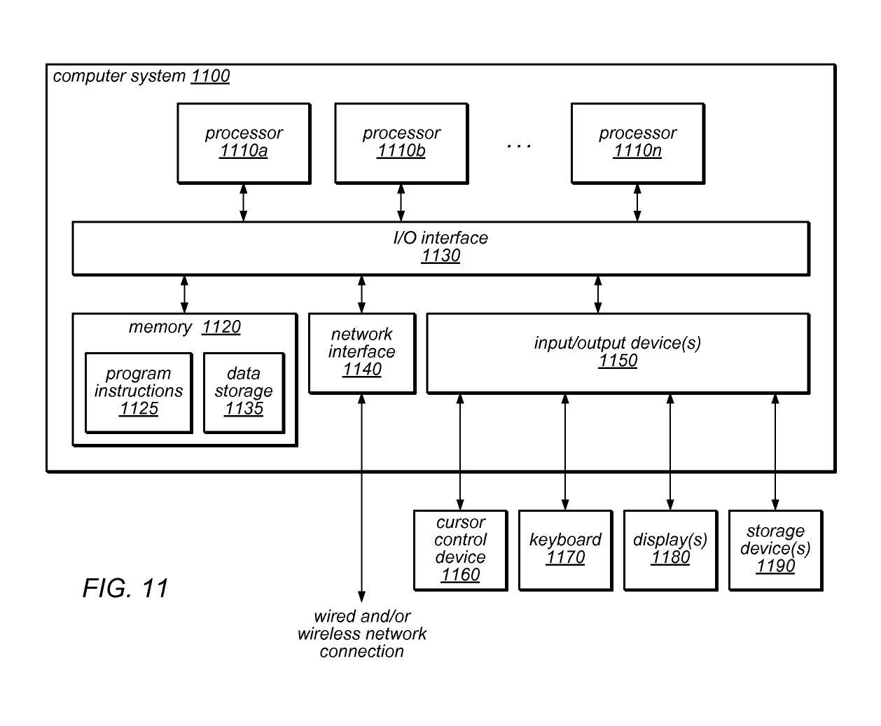

Embodiments of dynamically streaming font subsets as described herein may be executed on one or more computer systems, which may interact with various other devices. One such computer system is illustrated by FIG. 11. The computer system illustrated may implement either client or server functions. In different embodiments, computer system 1100 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1100 includes one or more processors 1110 coupled to a system memory 1120 via an input/output (I/O) interface 1130. Computer system 1100 further includes a network interface 1140 coupled to I/O interface 1130, and one or more input/output devices 1150, such as cursor control device 1160, keyboard 1170, display(s) 1180, and storage device(s) 1190. In some embodiments, it is contemplated that embodiments may be implemented using a single instance of computer system 1100, while in other embodiments multiple such systems, or multiple nodes making up computer system 1100, may be configured to host different portions or instances of embodiments. For example, in one embodiment some elements may be implemented via one or more nodes of computer system 1100 that are distinct from those nodes implementing other elements.

In various embodiments, computer system 1100 may be a uniprocessor system including one processor 1110, or a multiprocessor system including several processors 1110 (e.g., two, four, eight, or another suitable number). Processors 1110 may be any suitable processor capable of executing instructions. For example, in various embodiments, processors 1110 may be general-purpose or embedded processors implementing any of a variety of instruction set architectures (ISAs), such as the x86, PowerPC, SPARC, or MIPS ISAs, or any other suitable ISA. In multiprocessor systems, each of processors 1110 may commonly, but not necessarily, implement the same ISA.

In some embodiments, at least one processor 1110 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1120 may be configured to store program instructions and/or data accessible by processor 1110. In various embodiments, system memory 1120 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a module for streaming dynamic font subsets are shown stored within system memory 1120 as program instructions 1125 and data storage 1135, respectively. In other embodiments, program instructions and/or data may be received, sent or stored upon different types of computer-accessible media or on similar media separate from system memory 1120 or computer system 1100. Generally speaking, a computer-accessible medium may include storage media or memory media such as magnetic or optical media, e.g., disk or CD/DVD-ROM coupled to computer system 1100 via I/O interface 1130. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1140.

In one embodiment, I/O interface 1130 may be configured to coordinate I/O traffic between processor 1110, system memory 1120, and any peripheral devices in the device, including network interface 1140 or other peripheral interfaces, such as input/output devices 1150. In some embodiments, I/O interface 1130 may perform any necessary protocol, timing or other data transformations to convert data signals from one component (e.g., system memory 1120) into a format suitable for use by another component (e.g., processor 1110). In some embodiments, I/O interface 1130 may include support for devices attached through various types of peripheral buses, such as a variant of the Peripheral Component Interconnect (PCI) bus standard or the Universal Serial Bus (USB) standard, for example. In some embodiments, the function of I/O interface 1130 may be split into two or more separate components, such as a north bridge and a south bridge, for example. In addition, in some embodiments some or all of the functionality of I/O interface 1130, such as an interface to system memory 1120, may be incorporated directly into processor 1110.

Network interface 1140 may be configured to allow data to be exchanged between computer system 1100 and other devices attached to a network, such as other computer systems, or between nodes of computer system 1100. In various embodiments, network interface 1140 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1150 may, in some embodiments, include one or more display terminals, keyboards, keypads, touchpads, scanning devices, voice or optical recognition devices, or any other devices suitable for entering or retrieving data by one or more computer system 1100. Multiple input/output devices 1150 may be present in computer system 1100 or may be distributed on various nodes of computer system 1100. In some embodiments, similar input/output devices may be separate from computer system 1100 and may interact with one or more nodes of computer system 1100 through a wired or wireless connection, such as over network interface 1140.

As shown in FIG. 11, memory 1120 may include program instructions 1125, configured to implement embodiments of a module for dynamically streaming font subsets as described herein, and data storage 1135, comprising various data accessible by program instructions 1125. In one embodiment, program instructions 1125 may include software elements of embodiments of a module to dynamically stream font subsets as illustrated in the above Figures. Data storage 1135 may include data that may be used in embodiments. In other embodiments, other or different software elements and data may be included.

Those skilled in the art will appreciate that computer system 1100 is merely illustrative and is not intended to limit the scope of a module for dynamically streaming font subsets as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1100 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1100 may be transmitted to computer system 1100 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method, comprising:
performing by an application executing on a computer:
determining one or more characters in a content portion of a file specified in the file to be displayed in a particular font;
determining one or more glyphs of the font not currently available to the application for displaying the one or more determined characters in the particular font;
generating a message identifying the determined one or more glyphs, wherein the determined one or more glyphs are less than all glyphs defined in the particular font;
sending the message to a remote server; and
receiving from the remote server the determined one or more glyphs, wherein the received one or more glyphs are less than all glyphs in the particular font.

2. The method of claim 1, further comprising:
in response to receiving the determined one or more glyphs, populating at least a portion of a font data structure for the particular font with the received one or more glyphs.

3. The method of claim 2, further comprising:
determining one or more other characters in another content portion of another file specified in the other file to be displayed in the same particular font;
determining another one or more glyphs of the font not currently available to the application for displaying one or more other determined characters in the particular font;
generating another message identifying the determined other one or more glyphs, wherein the determined other one or more glyphs are less than all glyphs defined in the particular font;
sending the other message to the remote server; and
receiving from the remote server the determined other one or more glyphs, wherein the received other one or more glyphs are less than all glyphs in the particular font.

4. The method of claim 3, further comprising:
in response to receiving the determined other one or more glyphs, populating at least a portion of the font data structure for the particular font with the received other one or more glyphs.

5. The method of claim 3, wherein determining another one or more glyphs of the font not currently available to the application comprises determining whether the font data structure for the particular font available to the application contains glyphs corresponding to the one or more other characters.

6. The method of claim 2, wherein the font data structure is stored in persistent storage.

7. The method of claim 1, wherein the message comprises a request for a definition of a font data structure for the particular font and wherein the method further comprises:
receiving the definition of the font data structure for the particular font;
creating the font data structure for the particular font; and
in response to receiving the determined one or more glyphs, populating at least a portion of the font data structure for the particular font with the received one or more glyphs.

8. The method of claim 1, further comprising:
prior to sending the message, sending a request for a definition of a font data structure for the particular font;
receiving the definition of the font data structure for the particular font;
creating the font data structure for the particular font; and
in response to receiving the determined one or more glyphs, populating at least a portion of the font data structure for the particular font with the received one or more glyphs.

9. A computer-readable storage medium storing program instructions, wherein the program instructions are computer-executable to implement:
determining one or more characters in a content portion of a file specified in the file to be displayed in a particular font;
determining one or more glyphs of the font not currently available to the application for displaying the one or more determined characters in the particular font;
generating a message identifying the determined one or more glyphs, wherein the determined one or more glyphs are less than all glyphs defined in the particular font;
sending the message to a remote server; and
receiving from the remote server the determined one or more glyphs, wherein the received one or more glyphs are less than all glyphs in the particular font.

10. The computer-readable storage medium of claim 9, wherein the program instructions are computer-executable to implement:
in response to receiving the determined one or more glyphs, populating at least a portion of a font data structure for the particular font with the received one or more glyphs.

11. The computer-readable storage medium of claim 10, wherein the program instructions are computer-executable to implement:
determining one or more other characters in another content portion of another file specified in the other file to be displayed in the same particular font;
determining another one or more glyphs of the font not currently available to the application for displaying one or more other determined characters in the particular font;
generating another message identifying the determined other one or more glyphs, wherein the determined other one or more glyphs are less than all glyphs defined in the particular font;
sending the other message to the remote server; and
receiving from the remote server the determined other one or more glyphs, wherein the received other one or more glyphs are less than all glyphs in the particular font.

12. The computer-readable storage medium of claim 11, wherein the font data structure is stored in persistent storage and wherein the program instructions are computer-executable to implement:
in response to receiving the determined other one or more glyphs, populating at least a portion of the font data structure for the particular font with the received other one or more glyphs.

13. The computer-readable storage medium of claim 11, wherein determining another one or more glyphs of the font not currently available to the application comprises determining whether the font data structure for the particular font available to the application contains glyphs corresponding to the one or more other characters.

14. The computer-readable storage medium of claim 9, wherein the program instructions are computer-executable to implement:
receiving the definition of the font data structure for the particular font;
creating the font data structure for the particular font; and
in response to receiving the determined one or more glyphs, populating at least a portion of the font data structure for the particular font with the received one or more glyphs.

15. The computer-readable storage medium of claim 9, wherein the program instructions are computer-executable to implement:
prior to sending the message, sending a request for a definition of a font data structure for the particular font;
receiving the definition of the font data structure for the particular font;
creating the font data structure for the particular font; and
in response to receiving the determined one or more glyphs, populating at least a portion of the font data structure for the particular font with the received one or more glyphs.

16. A method, comprising:
performing by a computer:
receiving a request message from a remote application identifying one or more glyphs of a particular font, wherein the one or more glyphs are less than all glyphs defined in the particular font;
in response to receiving the request message:
parsing the request message to determine the particular one or more glyphs identified in the request message;
accessing a font data store to obtain the identified glyphs but not the entire font;
generating a reply message containing the one or more glyphs, wherein the reply message contains less than all of the glyphs defined in the font; and
sending the reply message to the remote application.

17. The method of claim 16, further comprising:
receiving another request message from the remote application requesting a definition of a font data structure for the particular font;
in response to receiving the other request message, generating another reply message containing the definition of the font data structure for the particular font; and
sending the other reply to the remote application.

18. The method of claim 16, wherein the request message comprises a request for a definition of a font data structure for the particular font, and wherein the method further comprises including in the reply message the definition of the font data structure for the particular font.

19. The method of claim 16, further comprising:
prior to said sending, determining that the remote application is authorized to receive the one or more glyphs.

20. The method of claim 19, wherein the request message comprises an identification of a content provider, and wherein said determining comprises determining that said content provider is authorized to provide a content portion of a file specifying characters to be displayed in the particular font.
